(19) United States
(12) Patent Application Publication
(10) Pub. No.: US 2021/0072880 A1
(43) Pub. Date: Mar. 11, 2021

(54) METHOD AND ELECTRONIC DEVICE FOR GENERATING AT LEAST ONE DATA ITEM FROM SCREENSHOT

(71) Applicant: Samsung Electronics Co., Ltd., Suwon-si (KR)

(72) Inventors: Akhila MATHUR, Noida (IN); Bokul BORAH, Noida (IN); Fateh SINGH, Noida (IN); Ranjesh VERMA, Noida (IN); Trisha Samir MODY, Noida (IN); Amitoj SINGH, Noida (IN); Upendra Shenoy MANGALAPADY, Noida (IN); Vipin TIWARI, Noida (IN); Pradnya Dasharath PATIL, Noida (IN)

(21) Appl. No.: 17/011,258

(22) Filed: Sep. 3, 2020

(30) Foreign Application Priority Data
Sep. 6, 2019 (IN) 201941036011

(51) Int. Cl. G06F 3/0484; G06F 3/0485; G06F 16/58; G06F 16/583

(52) U.S. Cl. CPC G06F 3/04842; G06F 16/583; G06F 16/5866; G06F 3/0485

(57) ABSTRACT

A method for generating at least one data item from a screenshot and an electronic device therefor are provided. The method includes detecting, by the electronic device, a screenshot comprising content displayed on a screen of the electronic device and determining, by the electronic device, data item parameters associated with the content in the screenshot. The method also includes generating, by the electronic device, at least one data item from the screenshot based on the data item parameters, and storing, by the electronic device, the at least one data item in a file in the electronic device.

### CROSS-REFERENCE TO RELATED APPLICATION(S)

This application is based on and claims priority under 35 U.S.C. § 119 of an Indian patent application number 201941036011, filed on Sep. 6, 2019, in the Indian Intellectual Property Office, the disclosure of which is incorporated by reference herein in its entirety.

### BACKGROUND

### 1. Field

The disclosure relates to performing actions in an electronic device. More particularly, the disclosure relates to a method and an electronic device for generating at least one data item from a screenshot.

### 2. Description of Related Art

In general, screenshots provide a view of a user interface of an electronic device (e.g., a view of an application window or a view of a computer desktop). When a user initiates a capture of a screenshot, the electronic device will create an image of a current state of the user interface of the electronic device. The user can then use the screenshot in a body of a document, share the screenshot etc.

However, the user may generally want to share only a portion of the screenshot and not the entire screenshot with another user or the user intends to use only the portion of the screenshot in the documents. In order to be able to use only the portion of the screenshot, the user will have to first capture the screenshot (e.g., as shown in screenshot 1 of FIG. 1, at 1) and then crop the screenshot to obtain only the relevant portion of the screenshot (e.g., as shown in screenshot 2 of FIG. 1), A result thereof is shown in screenshot 3 of FIG. 1. Further, the user may use the portion of the screenshot for performing actions like sharing, storing, attaching as part of the document, printing, etc. In case the user wants to extract another portion of the same screenshot, the user will have to repeat the above procedure which makes the process cumbersome for the user. Further, to avoid the cumbersome process the user may prefer sharing the entire screenshot which may lead to consumption of extra resources.

The above information is presented as background information only to assist with an understanding the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for generating at least one data item from a screenshot.

Another aspect of the disclosure is to determine a plurality of data item parameters associated with content in the screenshot.

Another aspect of the disclosure is to generate at least one data item from the screenshot based on the plurality of data item parameters.

Another aspect of the disclosure is to store the at least one data item in a file in the electronic device.

Another aspect of the disclosure is to perform at least one action in the electronic device using the at least one data item.

Another aspect of the disclosure is to determine whether the content displayed in a first image is complete based on a plurality of attributes.

Another aspect of the disclosure is to automatically scroll the content in at least one direction in response to determining that the content displayed in the first image is not complete, to capture the complete content in the screenshot.

Additional aspects will be set forth in part in the description which follows and, in part, will be apparent from the description, or may be learned by practice of the presented embodiments.

The method includes detecting, by the electronic device, a screenshot comprising content displayed on a screen of the electronic device and determining, by the electronic device, a plurality of data item parameters associated with the content in the screenshot. Further, the method also includes generating, by the electronic device, at least one data item from the screenshot based on the plurality of data item parameters, and storing, by the electronic device (100), the at least one data item in a file in the electronic device.

In an embodiment, the method further includes performing, by the electronic device, at least one action in the electronic device using the at least one data item.

In an embodiment, the method for detecting, by the electronic device, the screenshot comprising the content displayed on a screen of the electronic device includes receiving a first image of the content displayed on a screen of the electronic device and determining a plurality of attributes associated with the content displayed in the first image of the screen of the electronic device. Further, the method also includes determining whether the content displayed in the first image is complete based on the plurality of attributes and displaying an indication to scroll the content in at least one direction in response to determining that the content displayed in the first image is not complete. Furthermore, the method also includes receiving at least one second image of a scrolled content displayed on the screen of the electronic device, and detecting the screenshot based on the first image and the at least one second image.

In an embodiment, the method for generating, by the electronic device, the at least one data item from the screenshot based on the plurality of data item parameters includes displaying a plurality of objects available in the screenshot based on the plurality of data item parameters and detecting at least two objects from the plurality of objects selected by a user. Further, the method also includes selecting the at least two objects and generating a data item by automatically merging the at least two selected objects.

In an embodiment, the method for generating, by the electronic device, at least one data item from the screenshot based on the plurality of data item parameters includes determining a context associated with a plurality of objects available in the screenshot based on the plurality of data item parameters and determining a weightage of each of the objects based on the context. Further, the method also includes determining a set of objects from the plurality of objects for which the weightage meets a data item threshold, and generating at least one data item by automatically merging the set of objects.

In an embodiment, the plurality of data item parameters includes an outline of the content, proximity of the objects of the content and attributes of the content.

In an embodiment, the outline of the content includes information about at least one of edges of objects available in the screenshot (e.g., screen shot), line segments of objects available in the screenshot, angle of objects available in the screenshot, or a screen size of objects available in the screenshot.

In an embodiment, the attributes of the content include metadata information of the objects available in the screenshot.

In an embodiment, the proximity of the objects of the content indicates a distance between the objects available in the screenshot.

In accordance with another aspect of the disclosure, an electronic device for generating at least one data item from a screenshot is provided. The electronic device includes an imaging sensor, a memory and at least one processor coupled to the memory. The at least one processor is configured to detect a screenshot comprising content displayed on a screen of the electronic device, determine a plurality of data item parameters associated with the content in the screenshot, generate at least one data item from the screenshot based on the plurality of data item parameters, and store the at least one data item in a file in the electronic device.

Other aspects, advantages, and salient features of the disclosure will become apparent to those skilled in the art from the following detailed description, which, taken in conjunction with the annexed drawings discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example illustrating a method for generating a screenshot in an electronic device according to an embodiment of the disclosure;

FIG. 2A is a block diagram of the electronic device for generating at least one data item from the screenshot, according to an embodiment of the disclosure;

FIG. 2B illustrates a training phase of an object detection engine of the electronic device, according to an embodiment of the disclosure;

FIG. 2C illustrates an inference phase of the object detection engine of the electronic device, according to an embodiment of the disclosure;

FIG. 2D illustrates a method for determining whether a content displayed in a first image is complete based on plurality of attributes, according to an embodiment of the disclosure;

FIG. 2E illustrates a method for generating at least one data item from the screenshot based on an outline of at least one object, according to an embodiment of the disclosure;

FIG. 2F illustrates a method for generating the at least one data item from the screenshot based on an attribute of the at least one object, according to an embodiment of the disclosure;

FIG. 2G illustrates a method for generating at least one data item from the screenshot based on a weightage of each of the objects based on a context, according to an embodiment of the disclosure;

FIG. 3A is a flow chart illustrating a method for generating the at least one data item from the screenshot in the electronic device, according to an embodiment of the disclosure;

FIG. 3B is a flow chart illustrating a method for detecting the screenshot comprising the content displayed on the screen of the electronic device, according to an embodiment of the disclosure;

FIG. 3C is a flow chart illustrating a method for generating the at least one data item from the screenshot based on a plurality of data item parameters, according to an embodiment of the disclosure;

FIG. 3D is a flow chart illustrating another method for generating the at least one data item from the screenshot based on the plurality of data item parameters, according to an embodiment of the disclosure;

FIG. 3E is a flow chart illustrating a method for performing at least one action in the electronic device using the at least one data item, according to an embodiment of the disclosure;

FIG. 4 is an example illustrating the method for generating the at least one data item from the screenshot in the electronic device according to an embodiment of the disclosure;

FIG. 5A is an example illustrating a generation of the at least one data item from the screenshot based on a user selection, according to an embodiment of the disclosure;

FIG. 5B is another example illustrating the generation of the at least one data item from the screenshot based on the user selection, according to an embodiment of the disclosure;

FIG. 6A is an example illustration for scrolling the content to capture a complete image block for generating the at least one data item, according to an embodiment of the disclosure;

FIG. 6B is another example illustration for scrolling the content to capture the complete image block for generating the at least one data item, according to an embodiment of the disclosure;

FIG. 6C is an example illustration for scrolling the content to capture a complete text block for generating the at least one data item, according to an embodiment of the disclosure;

FIG. 7 is an example illustrating the generation of the at least one data item from the screenshot based on outlines of the objects of the content of the screenshot, according to an embodiment of the disclosure;

FIG. 8 is an example illustrating the generation of the at least one data item from the screenshot based on attributes of the objects of the content of the screenshot, according to an embodiment of the disclosure;

FIG. 9 is an example illustrating the generation of the at least one data item from the screenshot based on a proximity of the objects of the content of the screenshot, according to an embodiment of the disclosure;

FIG. 10A is an example illustrating the user performing the at least one action using a relevant application on the at least one data item generated from the screenshot, according to an embodiment of the disclosure;

FIG. 10B is an example illustrating the user performing the at least one action using a relevant application using the at least one data item selected by the electronic device, according to an embodiment of the disclosure;

FIG. 10C is an example illustrating the user performing the at least one action using a relevant application using the at least one data item selected by the user, according to an embodiment of the disclosure;

FIG. 11 is an example illustrating the performing of the at least one action on the at least one data item based on a user behavior and learning, according to an embodiment of the disclosure;

FIG. 12 is an example illustrating automatically masking of sensitive information in the screenshot, according to an embodiment of the disclosure; and

FIG. 13 is an example illustrating an auto-generation of the at least one data item from the screenshot, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as units, engines, manager, modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

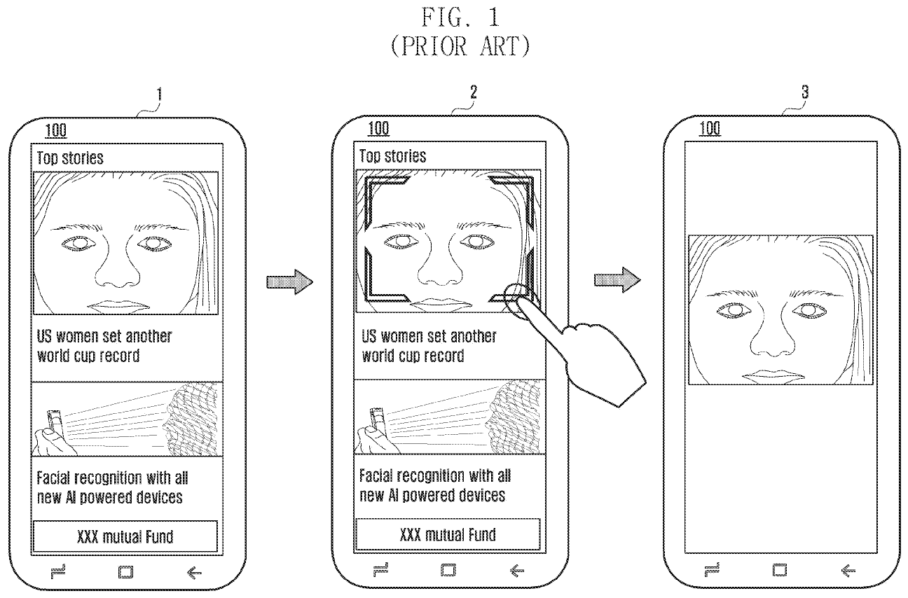

FIG. 1 is an example illustrating a method for generating a screenshot in an electronic device according to an embodiment of the disclosure.

Referring to FIG. 1, the embodiments herein provide a method for generating at least one data item from a screenshot in an electronic device (100). The method includes detecting, by the electronic device (100), a screenshot comprising content displayed on a screen of the electronic device (100) and determining, by the electronic device (100), a plurality of data item parameters associated with the content in the screenshot. Further, the method also includes generating, by the electronic device (100), at least one data item from the screenshot based on the plurality of data item parameters; and storing, by the electronic device (100), the at least one data item in a file in the electronic device (100).

In the methods and systems of the related art, when a user captures a screenshot of a user interface of an application and the user wants to share only a portion of the screenshot, then the user will have to manually crop the irrelevant portions of the screenshot and then share the relevant portion of the screenshot.

Unlike to the methods and systems of the related art, in the proposed method the electronic device (100) automatically determines at least one data item from the screenshot and provides the at least one data item to the user which can be stored, or shared, printed, etc., based on user requirement.

Unlike to the methods and systems of the related art, in the proposed method the electronic device (100) intelligently merges text block and an image block based on similarity of content and generates the at least one data item from the screenshot.

Unlike to the methods and systems of the related art, in the proposed method the user can drag and drop the screenshot comprising at least one data item onto an application and the electronic device (100) automatically determines a data item of the at least one data item which is associated with the application and performs the at least one action.

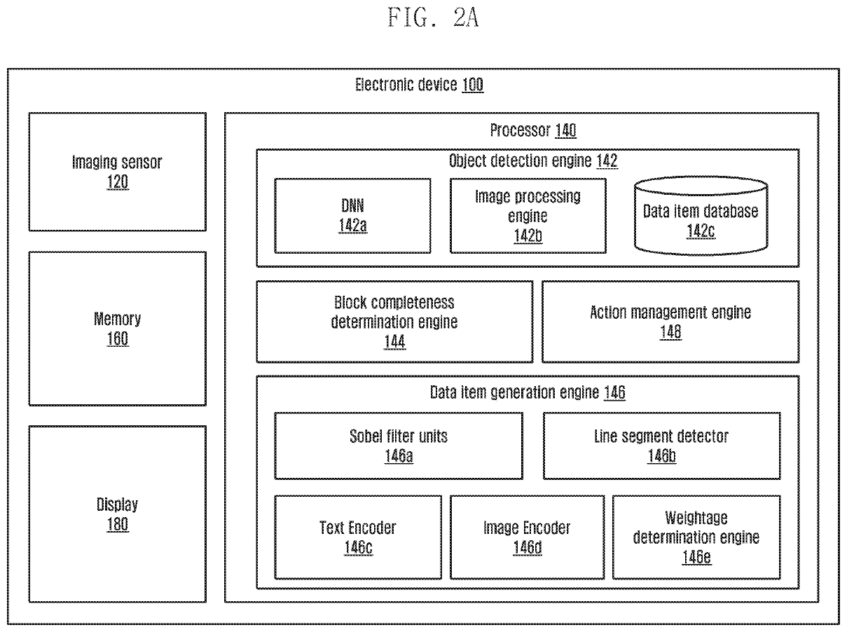

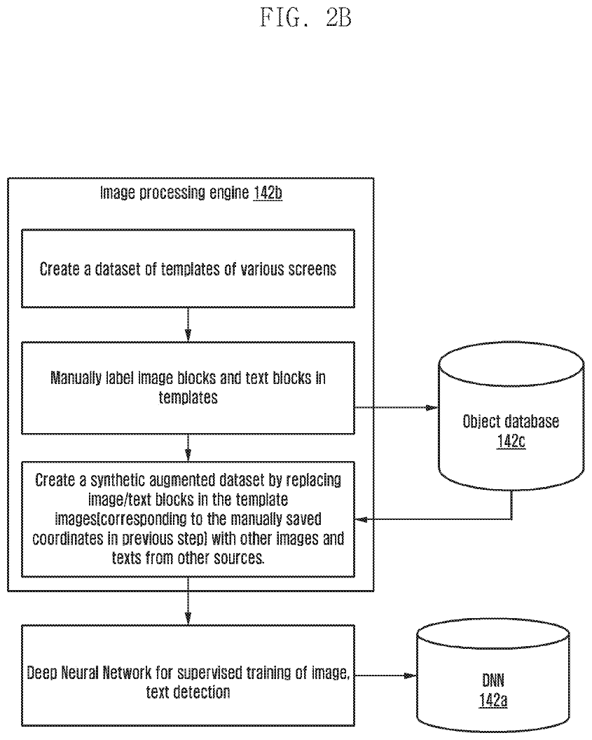

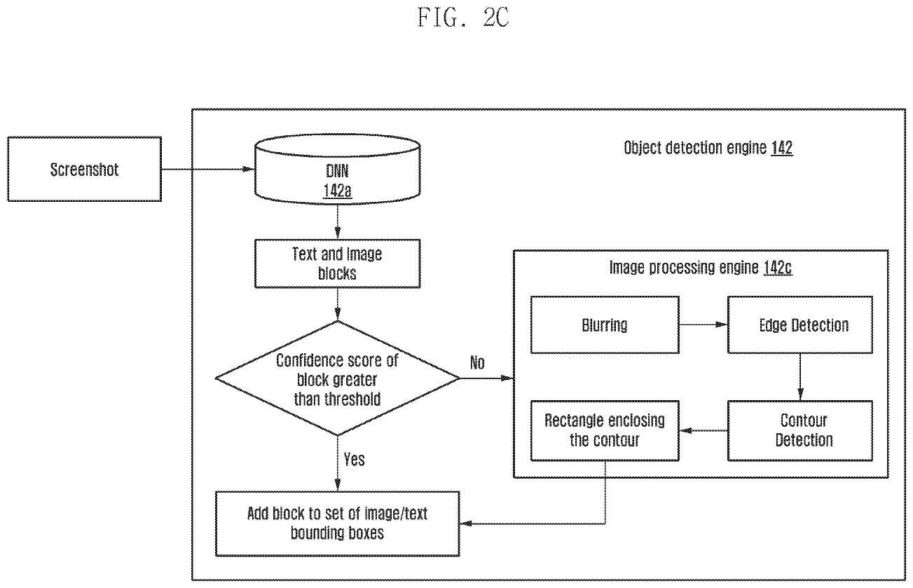

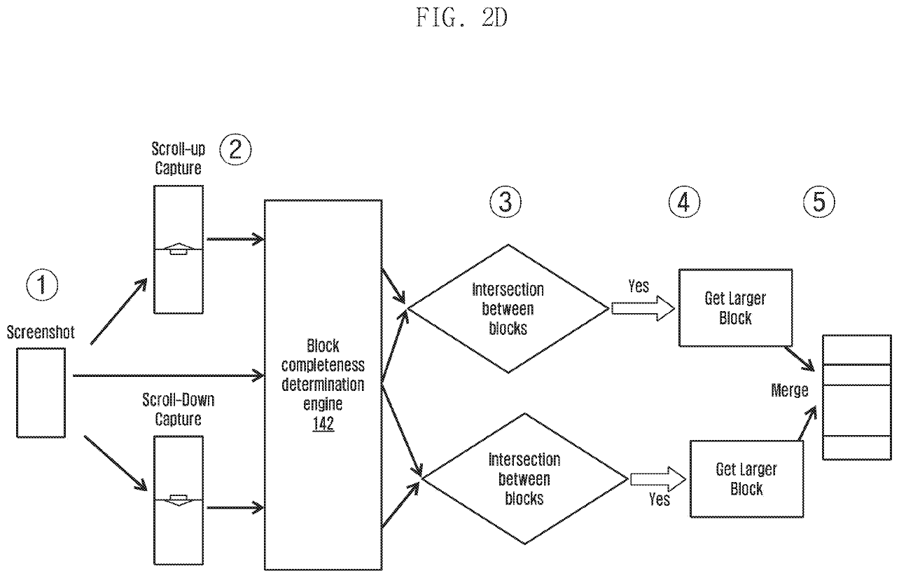

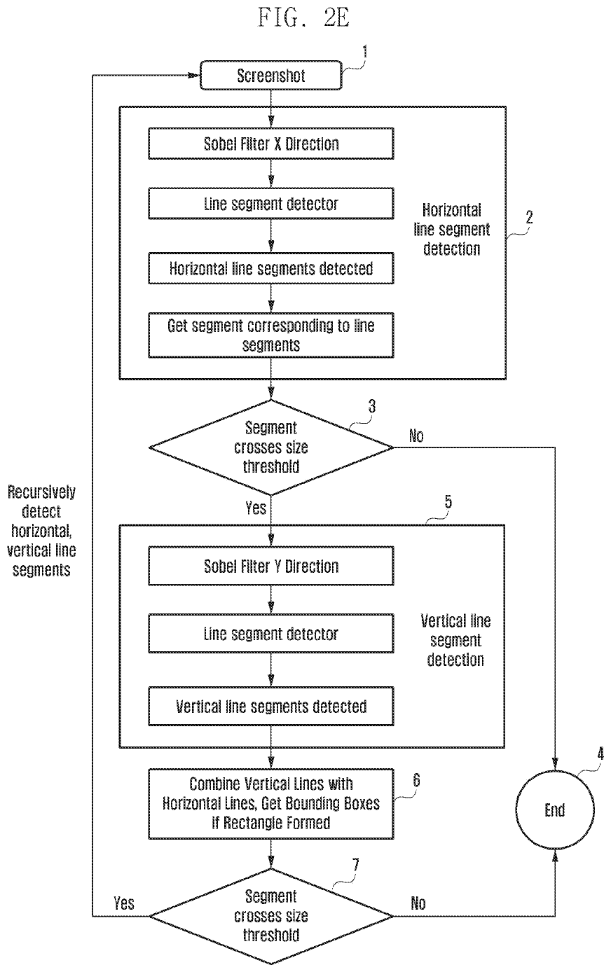

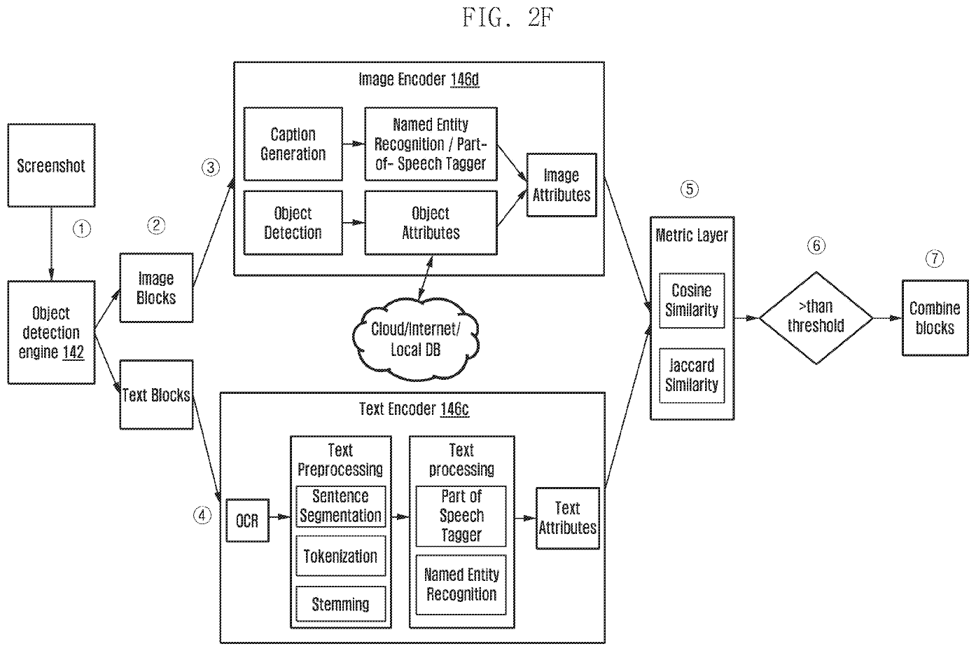

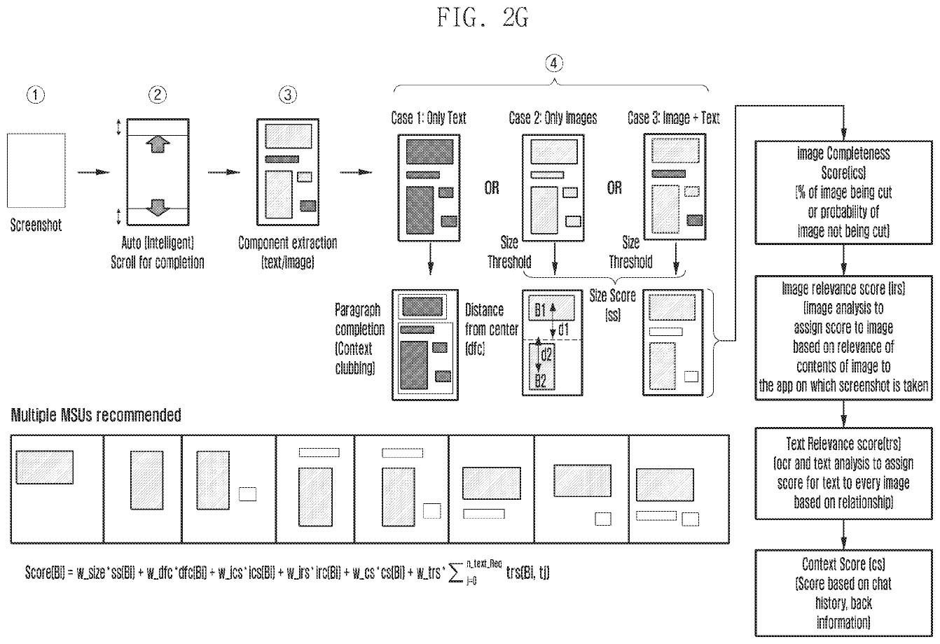

Referring now to the drawings, and more particularly to FIGS. 2A to 16, where similar reference characters denote corresponding features consistently throughout the figures, there are shown preferred embodiments.

FIG. 2A is a block diagram of the electronic device for generating at least one data item from a screenshot, according to an embodiment of the disclosure.

Referring to FIG. 2A, the electronic device (100) can be, for example, a mobile phone, a smart phone, Personal Digital Assistant (PDA), a tablet, a wearable device, or the like. In an embodiment, the electronic device (100) includes an imaging sensor (120), a processor (140), a memory (160) and a display (180).

In an embodiment, the imaging sensor (120) is configured to capture the screenshot of a user interface (UI) of the electronic device (100).

In an embodiment, the processor (140) is configured to detect the screenshot comprising content displayed on a screen of the electronic device (100) and determine a plurality of data item parameters associated with the content in the screenshot. The content displayed on the screen of the electronic device (100) comprises at least one of an image of an article, a text block, advertisement content, spaces between the article and the text block, etc. Further, the processor (140) is also configured to generate at least one data item from the screenshot based on the plurality of data item parameters associated with the content in the screenshot. The data item from the screenshot is a combination comprising at least one of the image block and the text block. The data item parameters associated with the content includes a metadata associated with the content in the screenshot.

Further, the processor (140) is configured to store the at least one data item in a file in the electronic device (100). The at least one data item can be stored in any form based on the generated data item. For example, in case the at least one data item generated is in the form of the image, then the at least one data item is stored as the image. The at least one data item can be generated as the image, a document, a search query, etc., and hence stored accordingly.

Furthermore, the processor (140) is also configured to perform at least one action in the electronic device (100) using the at least one data item. The at least one action is one of sharing the at least one data item generated by the processor (140) using various application in the electronic device (100), creating a search query in the various application in the electronic device (100) using the various application in the electronic device (100) generated by the processor (140), auto-masking of sensitive information in the at least one data item generated by the processor (140) based on a learning of a user behavior, etc.

The processor (140) includes an object detection engine (142), a block completeness determination engine (144), a data item generation engine (146), and an action management engine (148).

The object detection engine (142) further includes a Deep Neural Network (DNN) (142a), an image processing engine (142b) and an object database (142c). The object detection engine (142) is configured to analyze the screenshot captured by the electronic device (100) and detect at least one object in the screenshot. The at least one object includes at least one of an image block and a text block. The exact functioning of the object detection engine (142) is explained in FIGS. 2B to 2C.

The block completeness determination engine (144) is configured to determine whether the at least one of the image block and the text block is complete with respect to the content. In case of the image block, the block completeness determination engine (144) determines whether the image block is complete based on object attributes (e.g. metadata) and continuity of the image block. In case of the text block, the block completeness determination engine (144) determines whether the text block complete is based on grammatical and spatial completeness of the text block. In case the block completeness determination engine (144) determines that the at least one object is not complete, then the block completeness determination engine (144) displays an indication to scroll the content in at least one direction to obtain a complete screenshot of the at least one object.

In an embodiment, the data item generation engine (146) is configured to generate the at least one data item from the screenshot captured by the electronic device (100) after the at least one object is determined from the plurality of content in the screenshot and after the block completeness determination engine (144) provides the complete screenshot. The at least one data item may be generated using one of: a plurality data item parameter which includes an outline of the content, proximity of the objects of the content and attributes of the content; a weightage score associated with the image block and the text block of the screenshot; based on a selection of the at least one image block and the at least one text block manually by the user, etc. The data item generation engine (146) includes Sobel filter units (146a), line segment detector (146b), a text encoder (146c), an image encoder (146d), and a weightage determination engine (146e).

The Sobel filter units (146a) and the line segment detector (146b) are used to generate the at least one data item from the screenshot based on the outline of the content. The text encoder (146c) and the image encoder (146d) are used to generate the at least one data item from the screenshot based on the attributes of the content. The weightage determination engine (146e) is used to generate the at least one data item from the screenshot based on the weightage score associated with the image block and the text block of the screenshot which also includes the proximity of the objects of the content.

In an embodiment, the action management engine (148) is configured to perform the at least one action on the at least one data item generated by the data item generation engine (146). The at least one action may be one of sharing the at least one data item, printing the at least one data item, generating a search query using the at least one data item and populating search results, etc.

In an embodiment, the memory (160) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (160) may, in some examples, be considered a non-transitory storage medium. The term “non-transitory” may indicate that the storage medium is not embodied in a carrier wave or a propagated signal. However, the term “non-transitory” should not be interpreted that the memory (160) is non-movable. In some examples, the memory (160) is configured to store larger amounts of information than the memory (160). In certain examples, a non-transitory storage medium may store data that can, over time, change (e.g., in Random Access Memory (RAM) or cache).

In an embodiment, the display (180) is configured to display the screenshot on the screen of the electronic device (100). Further, the display (180) is also configured to display the at least one data item generated by the data item generation engine (146).

Although the FIG. 2A shows the hardware elements of the electronic device (100) but it is to be understood that other embodiments are not limited thereon. In other embodiments, the bendable device (100) may include less or more number of elements. Further, the labels or names of the elements are used only for illustrative purpose and does not limit the scope of the disclosure. One or more components can be combined together to perform same or substantially similar function.

FIG. 2B illustrates a training phase of the object detection engine (142) of the electronic device (100), according to an embodiment of the disclosure.

Referring to FIG. 2B, initially the DNN (142a) of the object detection engine (142) is trained for detecting at least two objects from the plurality of objects. An object is one of an image block and a text block in the screenshot. The image processing engine (142b) creates a dataset of templates of various application UIs. Further, a user manually labels the objects in the templates created by the image processing engine (142b). The labeled objects in the templates are also stored in the object database (142c) by the image processing engine (142b), which can be used for future reference. Further, the image processing engine (142b) creates a synthetic augmented dataset by replacing the object blocks in the template images with other objects received from other sources, after having saved a copy in the object database (142c).

Further, the templates are fed by the image processing engine (142b) to the DNN (142a) to be used for supervised training for performing object detection in the screenshot.

FIG. 2C illustrates an inference phase of the object detection engine (142) of the electronic device (100), according to an embodiment of the disclosure.

Referring to FIG. 2C, once the screenshot is captured by the imaging sensor (120), the screenshot comprising the content is fed as an input to the DNN (142a) of the object detection engine (142). The DNN (142a) determines the at least one object from the content i.e., at least one of the image block and the text block. Further, the DNN (142a) also computes a confidence score of at least one object determined in the screenshot and determines whether the confidence score of the at least one object is greater than a threshold of the confidence score. The confidence score is a probability that the content is one of the image and the text. The confidence score required in the proposed method has to be greater than 0.5 (which is the threshold of the confidence score).

In response to determining that the confidence score of at least one object determined in the screenshot is greater than the threshold of the confidence score, the image processing engine (142b) adds the at least one object to a set of at least one of image/text bounding boxes.

In response to determining that the confidence score of at least one object determined in the screenshot is greater than the threshold of the confidence score, the image processing engine (142b) performs various image processing techniques on the at least one object determined in the screenshot such as blurring, edge detection, contour detection, rectangle enclosing the contour and then adds the at least one object to a set of at least one of image/text bounding boxes.

FIG. 2D illustrates a method for determining whether the content displayed in a first image is complete based on the plurality of attributes, according to an embodiment of the disclosure.

Referring to FIG. 2D, at operation 1, a first image of the content (i.e., screenshot) is captured by the imaging sensor (120) and the block completeness determination engine (144) receives the first image of the content displayed on the screen of the electronic device (100). Further, at operation 2 shown in FIG. 2D, the block completeness determination engine (144) determines a plurality of attributes associated with the content displayed in the first image of the screen of the electronic device (100) such as size of the first image, pixels, dimensions, context associated with the content displayed etc. Further, the block completeness determination engine (144) determines whether the content displayed in the first image is complete based on the plurality of attributes.

Further, in response to determining that the content displayed in the first image is not complete, the block completeness determination engine (144) displays an indication to scroll the content in at least one direction. The content can be scrolled by the user manually based on the displayed by the block completeness determination engine (144) or the electronic device (100) can also auto-scroll in at least one direction to obtain the complete content. The at least one direction comprises scrolling the content in any of the four directions i.e., scroll to obtain content on top portion of the screen, scroll to obtain content on bottom portion of the screen, scroll to obtain content on left portion of the screen and scroll to obtain content on right portion of the screen. Further, at operation 3 shown in FIG. 2D, the block completeness determination engine (144) receives the at least one second image of the scrolled content displayed on the screen of the electronic device (100) and detects a region of intersection in the first image and the at least one second image. At operation 4 shown in FIG. 2D, the block completeness determination engine (144) obtains the larger block of the content in the screenshot based and at operation 5 shown in FIG. 2D, the block completeness determination engine (144) merges the first image and the second image over the region of intersection to obtain the complete screenshot of the content.

The complete content refers to a complete article or the complete paragraph of a document. For example, consider that in the first image of the screenshot only a portion of a house is displayed. Then, the second image is taken to obtain the complete image of the house displayed in the first image. Similarly, when the text block displayed in the first image is incomplete (determined based on the content), then the second image is obtained to obtain the complete paragraph of the text block displayed in the first image.

FIG. 2E illustrates a method for generating at least one data item from the screenshot based on an outline of the at least one object, according to an embodiment of the disclosure.

Referring to FIG. 2E, at operation 1, the data item generation engine (146) receives the screenshot from the block completeness determination engine (144) to further determine the data item in the screenshot after the object is detected and the completeness of the content is achieved in the previous hardware elements of the electronic device (100).

At operation 2 shown in FIG. 2E, horizontal line segments of the at least one object in the screenshot is detected by existing mechanisms. The detection of the horizontal line segment includes a Sobel Filter X Direction for horizontal edge detection, followed by a line segment detector for angle detection of the line segment. Further, once the line segments are detected, the data item generation engine (146) obtains the segment corresponding to line segments.

Further, at operation 3 shown in FIG. 2E, the data item generation engine (146) determines whether the segment corresponding to horizontal line segments crosses a size threshold. In response to determining that the segment corresponding to the horizontal line segments does not cross the size threshold, at operation 4 shown in FIG. 2E, the data item generation engine (146) terminates the procedure for generation of the at least one data item from the screenshot based on an outline of the at least one object.

In response to determining that the segment corresponding to the horizontal line segments crosses the size threshold, the data item generation engine (146), at operation 5 shown in FIG. 2E, proceeds for vertical line segment detection using a Sobel Filter Y direction for vertical edge detection, followed by the line segment detector for angle detection of the line segment. Further, at operation 6 shown in FIG. 2E, the data item generation engine (146) the data item generation engine (146) combines the vertical lines with the horizontal lines to obtain bounding boxes if a rectangle is formed on combining the vertical lines with the horizontal lines and then at operation 7 shown in FIG. 2E, the data item generation engine (146) determines whether the segment corresponding to vertical line segments crosses a size threshold. In response to determining that the segment corresponding to the vertical line segments does not cross the size threshold, the data item generation engine (146) terminates the procedure for generation of the at least one data item from the screenshot based on an outline of the at least one object (operation 4 shown in FIG. 2E).

In response to determining that the segment corresponding to the vertical line segments crosses the size threshold, the data item generation engine (146) recursively detects the horizontal line segment and the vertical line segment (multiple iterations from operation 1 shown in FIG. 2E). A table. 1 describes an example for the parameters associated with the Sobel Filter X Direction, the Sobel Filter Y Direction, the line segment detector and the segment size threshold.

TABLE 1

| | Parameters | Description |
|---|---|---|
| Sobel Filter | Kernel Size = 5 | Gradient calculation for |
| X Direction | | Horizontal edge detection |
| Sobel Filter | Kernel Size = 5 | Gradient calculation for |
| Y Direction | | Vertical edge detection |
| Line Segment | Angle of Line = 0 | Line segment detector |
| Detector | degree −1 degree | is used to generate a |
| | Angle of Line = 89 | Gaussian pyramid |
| | degree −90 degree | which is downsampled |
| | | N-1 times, blurred N |
| | | times, to obtain N |
| | | layers (one for each |
| | | octave), with layer 0 |
| | | corresponding to input |
| | | image and lines extracted. |
| | 20 pixels [tunable | 2. Small line segments |
| | parameter] | obtained are combined |
| | | if the distance between |
| | | parallel lines is less |
| | | than a certain threshold |
| | 50% [tunable | 3. Combined line segment |
| | parameter] | is considered in the final |
| | | set of line segments |
| | | if the length of combined |
| | | segment is greater than |
| | | a certain percentage |
| | | length of corresponding |
| | | dimension of the segment. |
| Segment Size | 2% of Screen size | If segment size is less |
| Threshold | | than 2% of screen size, |
| | | then no more horizontal, |
| | | vertical line segments |
| | | detected. |

FIG. 2F illustrates a method for generating the at least one data item from the screenshot based on an attribute of the at least one object, according to an embodiment of the disclosure.

Referring to FIG. 2F, at operation 1, the object detection engine (142) receives the screenshot comprising the content and at operation 2, the object detection engine (142) determines the image block and the text block from the content in the screenshot. Further, the image block and the text block from the screenshot are separately analyzed.

At operation 3 shown in FIG. 2F, the image block is fed to an image encoder (146d) of the data item generation engine (146) for determining the attributes associated with the image block. Initially a caption is generated for the image block (using an existing method) by converting the image into text description of the image. Simultaneously, the object detection is performed to determine the object in the image block such as a human figure, a vehicle, a landscape, a building, etc. Further, the object attributes include the metadata associated with the detected object such as for example if the object detected is a car, then the object attributes include a color of the car, a brand of the car, a price of the car, locations where the car is available for purchase, etc., which are determined from the image block and also from a cloud server/internet access. Therefore, the image attributes are a combination of all the information obtained as object attributes, caption of the image block, etc.

At operation 4 shown in FIG. 2F, the text block is fed to a text encoder (146c) which determines the text attributes using the existing methods. Further, at operation 5 shown in FIG. 2F, the object detection engine (142) includes a metric layer for determining a similarity between the image attributes and the text attributes and checks whether the similarity is greater than a data item threshold. On determining that the similarity is greater than a data item threshold (at operation 6 shown in FIG. 2F), then the image block and text block are combined to form the data item which is then stored in the data item database or object database (142c) (at operation 7 shown in FIG. 2F).

FIG. 2G illustrates a method for generating at least one data item from the screenshot based on a weightage of each of the objects based on the context, according to an embodiment of the disclosure.

Referring to FIG. 2G, at operation 1, the electronic device (100) captures the screenshot comprising the plurality of content and at operation 2, the electronic device (100) auto scrolls and captures the complete screenshot in case the content in the screenshot is not complete. At operation 3 shown in FIG. 2G, the electronic device (100) identifies and extracts the at least one object which is at least one of the image block and the text block.

At operation 4 shown in FIG. 2G, in case the at least one object extracted includes only the text block, then the electronic device (100) determines the paragraph completion of the text block based on grammatical and spatial completeness.

At operation 4 shown in FIG. 2G, in case the at least one object extracted includes only the image block, then the electronic device (100) determines a distance of the image blocks from the center (dfc) of the screenshot. At operation 4 shown in FIG. 2G, in case the at least one object extracted includes both the image block and the text block, then the electronic device (100) determines a size threshold which is used to determine a size score (ss) for the image block and the text block.

Further, a series of parameters are considered for determining a weighted score by the weightage determination engine (146e) which is in turn used to determine the generation of the at least one data item based on the weighted score. The series of parameters considered for determining the weighted score by the weightage determination engine (146e) includes a size of the at least one object, a distance from the center, image completeness score (ics) which indicates a percentage of the image block being cut or a probability of the image block not being cut, an image relevance score (irs) which performs an image analysis to assign score to image based on relevance of the contents of the image block to the application on which the screenshot is taken, a text relevance score (trs) which is obtained based on an optical character recognition (OCR) and a text analysis to assign score for the text to every image based on the relationship, and a context score (cs) which is a score based on a chat history, back information, learning, etc.

Accordingly, the following equation may be used:

Weighted score(Bi)=w_size**ss(Bi)+w_dfc*dfc(Bi)+w_ics*ics(Bi)+w_irs*irs(Bi)+w_cs*cs(Bi)+w_trs*Σⱼ₌₀^{n_text_req}trs(Bi,tj) Equation 1

Further, the weightage determination engine (146e) of the electronic device (100) determines whether the weighted score meets a data item threshold and in response to determining that the weighted score meets the data item threshold, the at least one data item is generated by the electronic device (100).

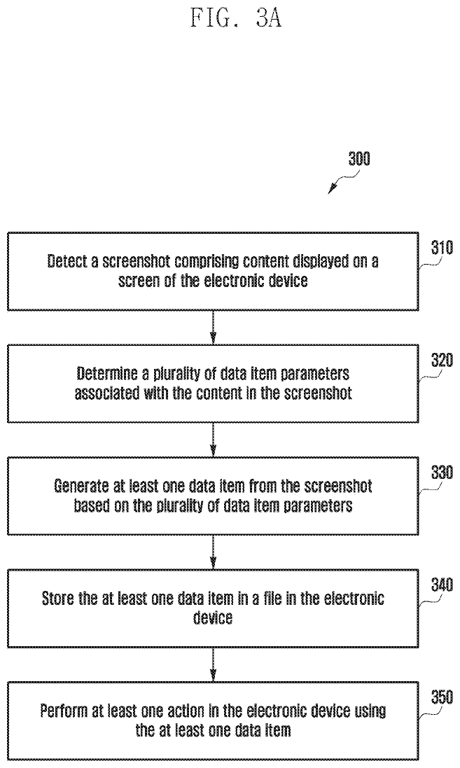

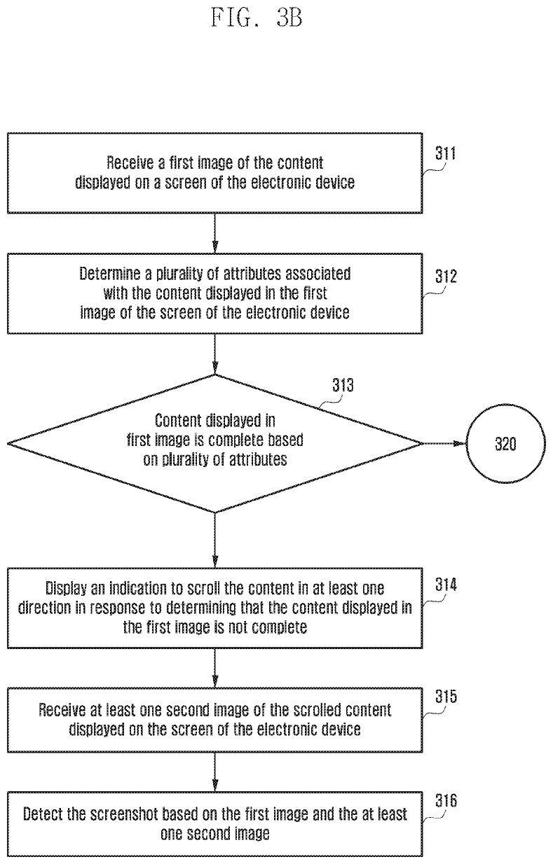

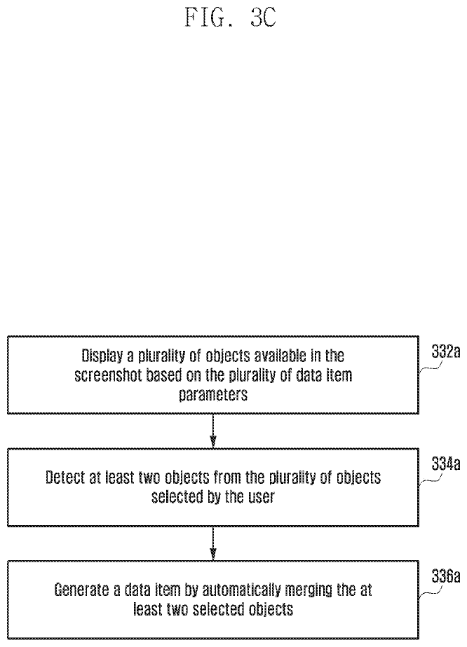

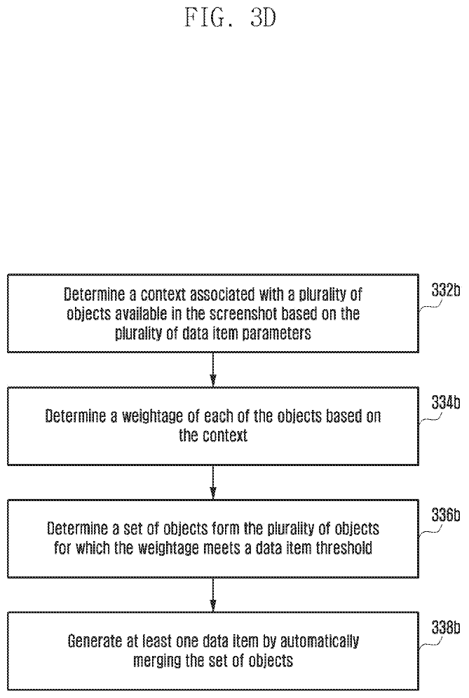

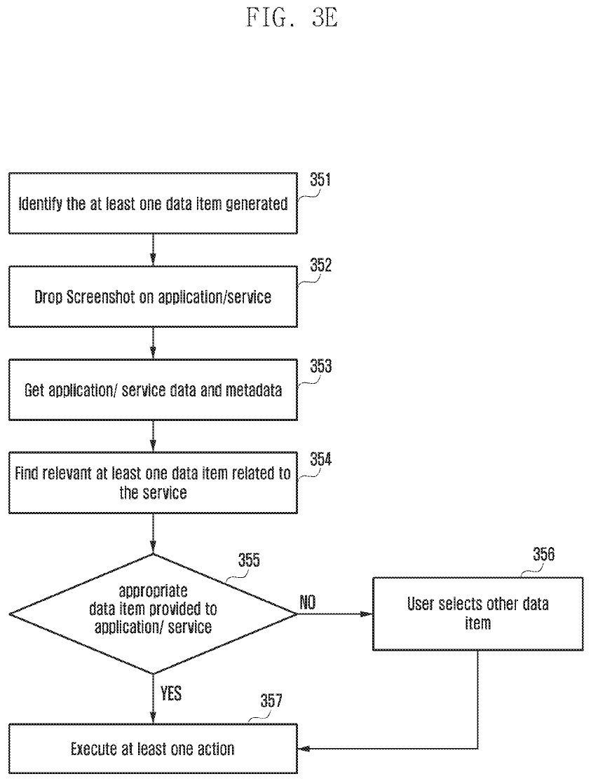

FIG. 3A is a flow chart 300 illustrating a method for generating the at least one data item from the screenshot in the electronic device (100), according to an embodiment of the disclosure.

Referring to FIG. 3A, at operation 310 the electronic device (100) detects the screenshot comprising the content displayed on the screen of the electronic device (100). For example, in the electronic device (100) as illustrated in the FIG. 2A, the processor (140) can be configured to detect the screenshot comprising the content displayed on the screen of the electronic device (100).

At operation 320, the electronic device (100) determines the plurality of data item parameters associated with the content in the screenshot. For example, in the electronic device (100) as illustrated in the FIG. 2A, the processor (140) can be configured to determine the plurality of data item parameters associated with the content in the screenshot.

At operation 330, the electronic device (100) generates the at least one data item from the screenshot based on the plurality of data item parameters. For example, in the electronic device (100) as illustrated in the FIG. 2A, the processor (140) can be configured to generate the at least one data item from the screenshot based on the plurality of data item parameters.

At operation 340, the electronic device (100) stores the at least one data item in the file. For example, in the electronic device (100) as illustrated in the FIG. 2A, the processor (140) can be configured to store the at least one data item in the file.

At operation 350, the electronic device (100) performs the at least one action using the at least one data item. For example, in the electronic device (100) as illustrated in the FIG. 2A, the processor (140) can be configured to perform the at least one action using the at least one data item.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

FIG. 3B is a flow chart illustrating a method for detecting the screenshot comprising the content displayed on the screen of the electronic device (100), according to an embodiment of the disclosure.

Referring to FIG. 3B, at operation 311 the electronic device (100) receives the first image of the content displayed on the screen. For example, in the electronic device (100) as illustrated in the FIG. 2A, the processor (140) can be configured to receive the first image of the content displayed on the screen of the electronic device (100).

At operation 312, the electronic device (100) determines the plurality of attributes associated with the content displayed in the first image of the screen. For example, in the electronic device (100) as illustrated in the FIG. 2A, the processor (140) can be configured to determine the plurality of attributes associated with the content displayed in the first image of the screen.

At operation 313, the electronic device (100) determines whether the content displayed in the first image is complete based on the plurality of attributes. For example, in the electronic device (100) as illustrated in the FIG. 2A, the processor (140) can be configured to determine whether the content displayed in the first image is complete based on the plurality of attributes.

At operation 314, the electronic device (100) displays the indication to scroll the content in the at least one direction in response to determining that the content displayed in the first image is not complete. For example, in the electronic device (100) as illustrated in the FIG. 2A, the processor (140) can be configured to display the indication to scroll the content in the at least one direction in response to determining that the content displayed in the first image is not complete.

At operation 315, the electronic device (100) receives the at least one second image of the scrolled content displayed on the screen. For example, in the electronic device (100) as illustrated in the FIG. 2A, the processor (140) can be configured to receive the at least one second image of the scrolled content displayed on the screen.

At operation 316, the electronic device (100) detects the screenshot based on the first image and the at least one second image. For example, in the electronic device (100) as illustrated in the FIG. 2A, the processor (140) can be configured to detect the screenshot based on the first image and the at least one second image.

FIG. 3C is a flow chart illustrating a method for generating the at least one data item from the screenshot based on the plurality of data item parameters, according to an embodiment of the disclosure.

Referring to FIG. 3C, at operation 332a the electronic device (100) displays the plurality of objects available in the screenshot based on the plurality of data item parameters. For example, in the electronic device (100) as illustrated in the FIG. 2A, the processor (140) can be configured to display the plurality of objects available in the screenshot based on the plurality of data item parameters.

At operation 334a the electronic device (100) detects the at least two objects from the plurality of objects selected by the user. For example, in the electronic device (100) as illustrated in the FIG. 2A, the processor (140) can be configured to detects the at least two objects from the plurality of objects selected by the user.

At operation 336a the electronic device (100) generates the data item by automatically merging the at least two selected objects. For example, in the electronic device (100) as illustrated in the FIG. 2A, the processor (140) can be configured to generate the data item by automatically merging the at least two selected objects.

FIG. 3D is a flow chart illustrating another method for generating the at least one data item from the screenshot based on the plurality of data item parameters, according to an embodiment of the disclosure.

Referring to FIG. 3D, at operation 332b the electronic device (100) determines the context associated with the plurality of objects available in the screenshot based on the plurality of data item parameters. For example, in the electronic device (100) as illustrated in the FIG. 2A, the processor (140) can be configured to determine the context associated with the plurality of objects available in the screenshot based on the plurality of data item parameters.

At operation 334b the electronic device (100) determines the weightage of each of the objects based on the context. For example, in the electronic device (100) as illustrated in the FIG. 2A, the processor (140) can be configured to determine the weightage of each of the objects based on the context.

At operation 336b the electronic device (100) determines the set of objects from the plurality of objects for which the weightage meets the data item threshold. For example, in the electronic device (100) as illustrated in the FIG. 2A, the processor (140) can be configured to determine the set of objects from the plurality of objects for which the weightage meets the data item threshold.

At operation 338b the electronic device (100) generates the at least one data item by automatically merging the set of objects. For example, in the electronic device (100) as illustrated in the FIG. 2A, the processor (140) can be configured to generate the at least one data item by automatically merging the set of objects.

FIG. 3E is a flow chart illustrating a method for performing at least one action in the electronic device (100) using the at least one data item, according to an embodiment of the disclosure.

Referring to FIG. 3E, at operation 351 the electronic device (100) identifies the at least one data item generated. For example, in the electronic device (100) as illustrated in the FIG. 2A, the processor (140) can be configured to identify the at least one data item generated.

At operation 352, the electronic device (100) allows the user to drop the screenshot on the application/service. For example, in the electronic device (100) as illustrated in the FIG. 2A, the processor (140) can be configured to allow the user to drop the screenshot on the application/service.

At operation 353, the electronic device (100) gets the application/service data and metadata associated with the application. For example, in the electronic device (100) as illustrated in the FIG. 2A, the processor (140) can be configured to get the application/service data and metadata associated with the application.

At operation 354, the electronic device (100) finds the at least one data item related to the service/application. For example, in the electronic device (100) as illustrated in the FIG. 2A, the processor (140) can be configured to find the at least one data item related to the service/application.

At operation 355, the electronic device (100) determines whether the appropriate data item is provided to the application/service. For example, in the electronic device (100) as illustrated in the FIG. 2A, the processor (140) can be configured to) determine whether the appropriate data item is provided to the application/service.

At operation 356, in response to determining that the appropriate data item is not provided to the application/service, the electronic device (100) allows the user to select another data item.

At operation 357, in response to determining that the appropriate data item is provided to the application/service, the electronic device (100) executes the at least one action based on the application/service into which the screenshot is dropped by the user. For example, in the electronic device (100) as illustrated in the FIG. 2A, the processor (140) can be configured to executes the at least one action based on the application/service into which the screenshot is dropped by the user, in response to determining that the appropriate data item is provided to the application/service.

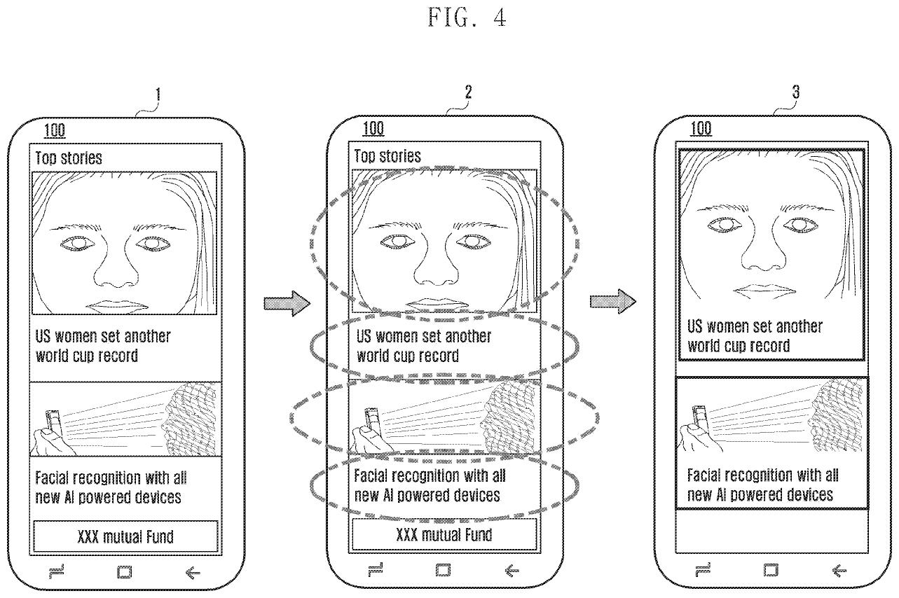

FIG. 4 is an example illustrating the method for generating the at least one data item from the screenshot in the electronic device (100) according to an embodiment of the disclosure.

Referring to FIG. 4, shown at screenshot 1, the electronic device (100) captures the screenshot of a user interface of an application which comprises a plurality of content.

Shown at screenshot 2 of FIG. 4, the electronic device (100) determines the plurality of data item parameters associated with the content in the screenshot such as an outline of the content, proximity of objects of the content and attributes of the content. Further, shown at screenshot 3 of FIG. 4, the electronic device (100) generates two data items from the screenshot based on the plurality of data item parameters. Further, the electronic device (100) stores the two data items in an image file, as the generated two data items are images. Also, the electronic device (100) allows the user to perform actions on the two data items such as sharing the individual data items using a messaging application.

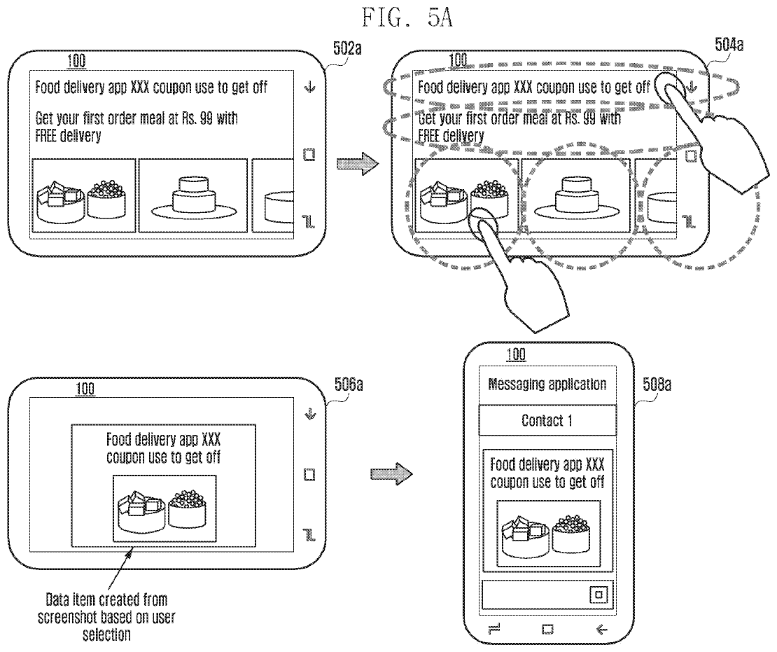

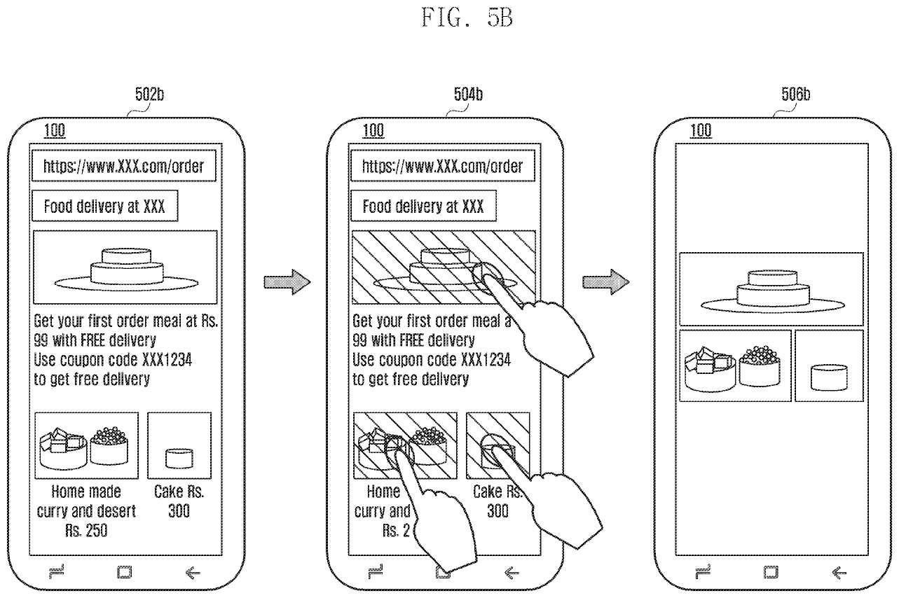

FIG. 5A is an example illustrating a generation of the at least one data item from the screenshot based on a user selection, according to an embodiment of the disclosure.

Referring to FIG. 5A, at screenshot 502a, the electronic device (100) receives the screenshot comprising the plurality of contents captured by the user. At screenshot 504a, the electronic device (100) highlights the plurality of objects from the screenshot which can be selected to form the at least one data item. Further, the electronic device (100) allows the user to select at least two objects from the plurality of objects to be used for generating the at least one data item and the user selects tow objects i.e., one image block and one text block from the plurality of objects in the screenshot.

At screenshot 506a of FIG. 5A, the electronic device (100) combines the image block and the text block selected by the user to generate a single data item, as shown in the FIG. 5A. Further, at screenshot 508a of FIG. 5A, the user shares the data item with the user contact using the messaging application.

FIG. 5B is another example illustrating the generation of the at least one data item from the screenshot based on the user selection, according to an embodiment of the disclosure.

Referring to FIG. 5B in conjunction with the FIG. 5A, the screenshots 502b to 504b may be substantially the same as screenshots 502a to 504a, and, thus repeated description is omitted. However, at screenshot 504b, the user selects three image blocks from the plurality of objects of the screenshot. At screenshot 506b, the electronic device (100) combines the three image blocks selected by the user to generate a single data item, as shown in the FIG. 5B. Further, the electronic device (100) stores the data item generated in the and also allow the user to perform at least one action on the data item.

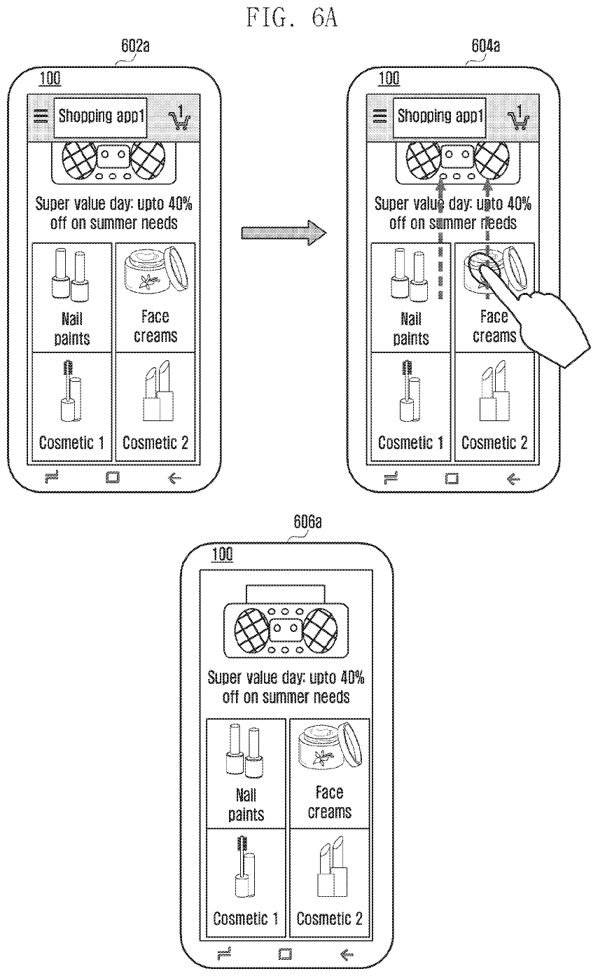

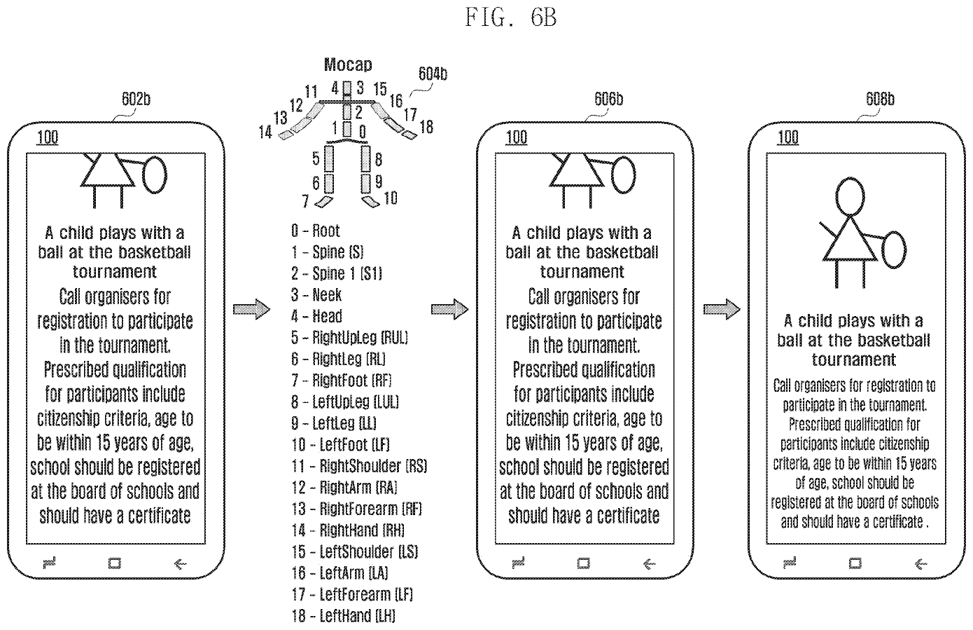

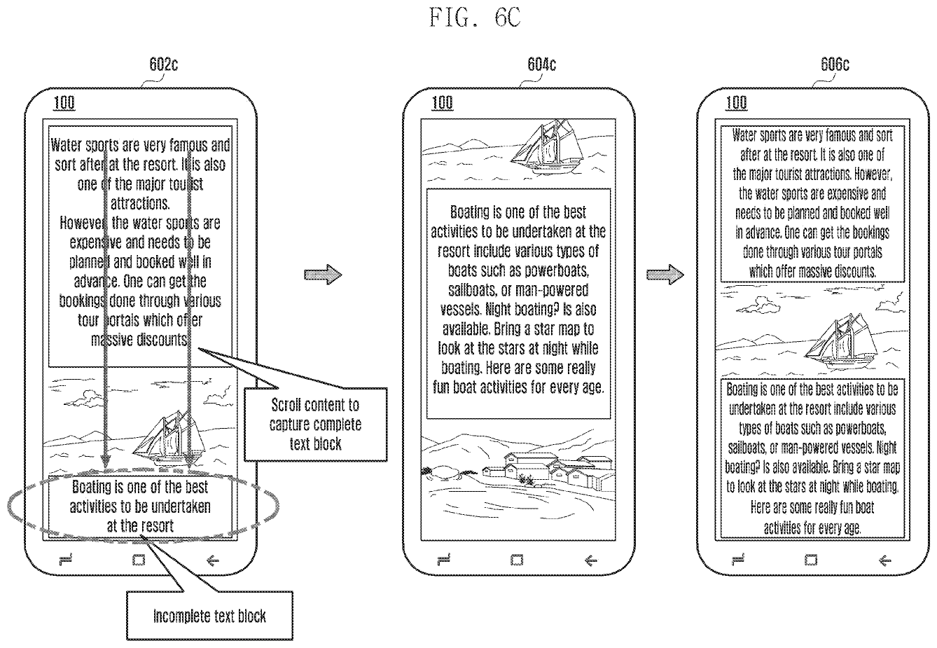

FIG. 6A is an example illustration for scrolling the content to capture a complete image block for generating the at least one data item, according to an embodiment of the disclosure.

Referring to FIG. 6A, at screenshot 602a, the electronic device (100) captures the first image of the UI of the shopping application comprising the plurality of contents which include image blocks of products such as a radio, cosmetics, etc., and text blocks.

At screenshot 604a, the electronic device (100) determines the plurality of attributes associated with the content displayed in the first image such as the color and size of the products displayed, continuity of the product and any other metadata associated with the products displayed in the first image. Further, the electronic device (100) determines that the radio displayed in the first image is not complete based on the plurality of attributes and displays an indication to scroll-up the content to capture the complete radio. The scroll-up can be performed by one of automatically by the electronic device (100) and manually by the user.

At screenshot 606a, the electronic device (100) receives the second image of the radio displayed on the screen of the electronic device (100) along with the other products and generates a complete screenshot based on the first image and the second image. Further, the electronic device (100) generates the at least one data item from the complete screenshot on which the user can perform the at least one action.

FIG. 6B is another example illustration for scrolling the content to capture a complete image block for generating the at least one data item, according to an embodiment of the disclosure.

Referring to FIG. 6B, at screenshot 602b, the electronic device (100) captures the first image of a news article comprising a human figure and the text block. At screenshot 604b, the electronic device (100) identifies the human figure and the attributes associated with the human figure such as for example, hands, legs, hips, posture, etc. and fetches all attributes associated with the human figure. At screenshot 606b, the electronic device (100) performs the auto-scroll of the content in the first image to obtain the complete human figure. At screenshot 608b, the electronic device (100) captures the second image comprising the complete human figure and then generates the complete screenshot by merging the first image and the second image at the region of intersection of the first image and the second image. Further, the electronic device (100) determines the data items in the complete screenshot on which the at least one action can be performed.

FIG. 6C is an example illustration for scrolling the content to capture a complete text block for generating the at least one data item, according to an embodiment of the disclosure.

Referring to FIG. 6C, at screenshot 602c, the electronic device (100) captures the first image of a news article comprising the plurality of content. Further, the electronic device (100) identifies that the first text block is complete followed by the first image block which is also complete and determines that the second text block is grammatically incomplete.

Furthermore, the electronic device (100) determines the properties of the electronic device (100) such as length in pixels, etc., and performs the auto-scroll down of the content in the first image to complete the second text block. At screenshot 604c, the electronic device (100) captures the second image comprising the complete second text block after scrolling down the content in the first image. Further, the electronic device (100) merges the first image and the second image of the second text block and then determines whether the text/image block displayed at the bottom most portion of the screenshot is grammatically and spatially complete.

At screenshot 606c, in response to determining that the text/image block displayed at the bottom most portion of the screenshot is grammatically and spatially complete, the electronic device (100) generates the complete screenshot by merging the first image and the second image at the region of intersection of the first image and the second image. Further, the electronic device (100) determines the data items in the complete screenshot on which the at least one action can be performed.

In response to determining that the text/image block displayed at the bottom most portion of the screenshot is grammatically and spatially incomplete, the electronic device (100) scrolls down further to capture the complete text/image block and then forms the complete screenshot by merging the first image with the at least one second image.

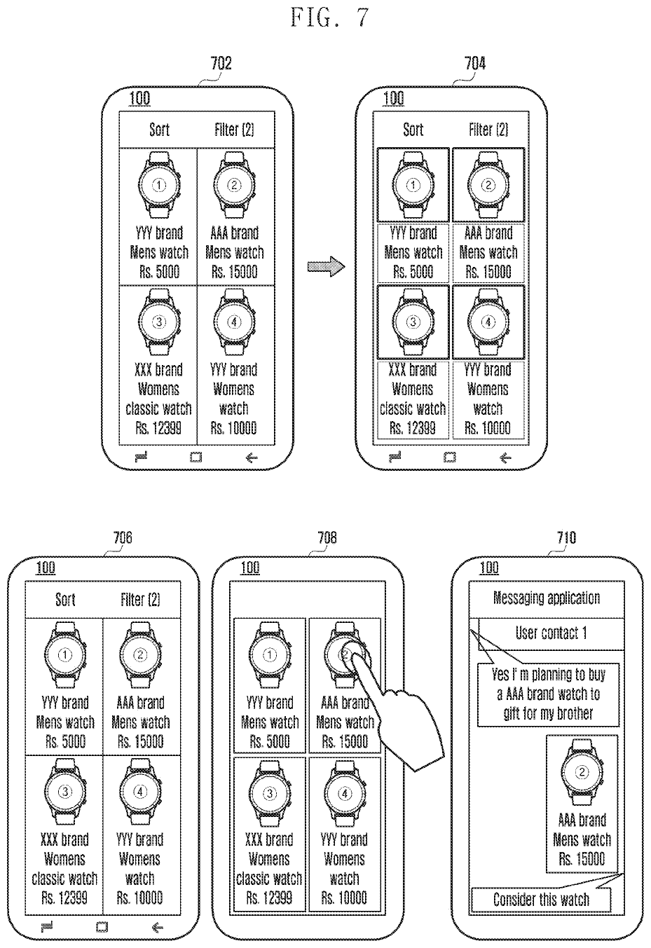

FIG. 7 is an example illustrating the generation of the at least one data item from the screenshot based on the outlines of the objects of the content of the screenshot, according to an embodiment of the disclosure.

Referring to FIG. 7, at 702, consider that the user has captured a screenshot of shopping application displaying a plurality of watches and comprising both text blocks and image blocks.

At screenshot 704, the electronic device (100) determines each of the text blocks and the image blocks from the contents of the screenshot. At screenshot 706, the electronic device (100) identifies the outlines already present in the screenshot. Further, at screenshot 708, the electronic device (100) merges the text block and the image block which are within the existing outline of the screenshot to form at least one data item and determines whether the at least one data item generated matches the data item threshold. In response to determining that the at least one data item generated matches the data item threshold, the electronic device (100) provides the at least one data item to the user.

In another embodiment, the electronic device (100) determines a context associated with a user communication with the user contact and automatically provides the data item based on the context. From the above example, consider that before capturing the screenshot the user was chatting with a user contact 1 regarding buying a watch of AAA brand to gift for a brother of the user contact 1. The electronic device (100) identifies the context of the chat as watch and also extracts text such as the AAA brand. When the user at screenshot 702 captures the screenshot of the watches in the shopping application, the electronic device (100) automatically generates the data item of the AAA brand watch and provides the data item in the messaging application for the user to share with the user contact 1 (e.g., at screenshot 710). Therefore, the proposed method provides minimum disruption between the user communication for capturing and sharing the screenshot of the watch, thereby enhancing user experience.

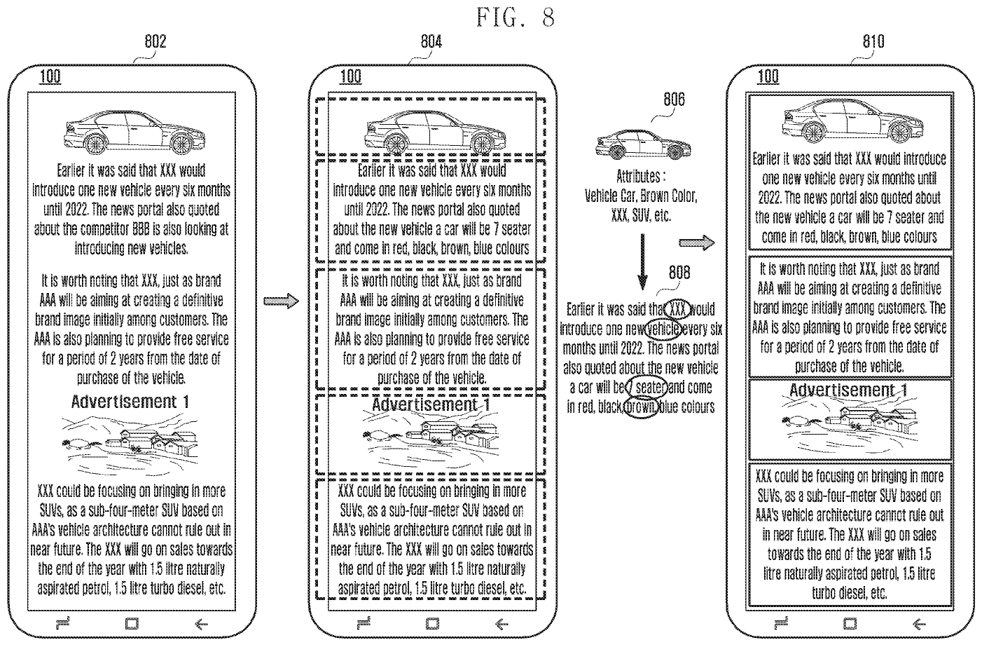

FIG. 8 is an example illustrating the generation of the at least one data item from the screenshot based on the attributes of the objects of the content of the screenshot, according to an embodiment of the disclosure.

Referring to FIG. 8, at screenshot 802, consider that the user has captured a screenshot of a news article comprising both text blocks and image blocks along with an advertisement image using the electronic device (100).

At screenshot 804, the electronic device (100) determines each of the text blocks and the image blocks from the contents of the screenshot. At screenshot 806, the electronic device (100) identifies the objects from the image block as a vehicle. Further, at screenshot 806, the electronic device (100) determines the attributes associated with the vehicle based on the metadata of the image block such as for example the vehicle is a car, the color of the car is brown, the car belongs to brand XXX and may be a sports utility vehicle (SUV), etc. At screenshot 808, the electronic device (100) performs the text detection on the text block which is in close proximity to the image block in the screenshot and matches the attributes obtained from the image block to the contents of the text block. Further, at screenshot 810, the electronic device (100) automatically generates the data item by merging the image block consisting the car with the text block which has matching text content based on the attributes of the car.

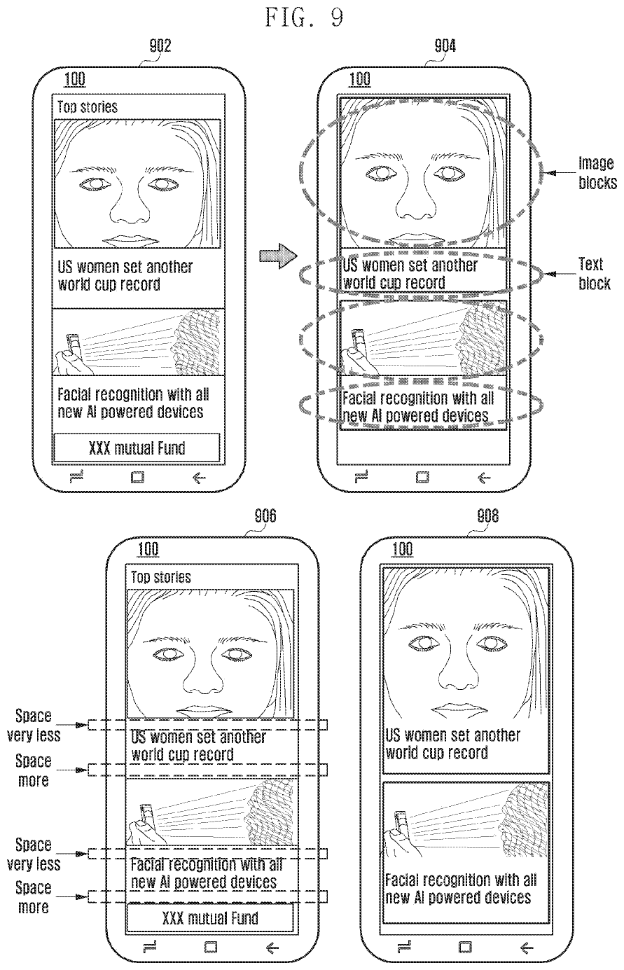

FIG. 9 is an example illustrating a generation of the at least one data item from the screenshot based on a proximity of the objects of the content of the screenshot, according to an embodiment of the disclosure.

Referring to FIG. 9, at screenshot 902, consider the user captures the screenshot using the electronic device (100) of a news application displaying the plurality of content (i.e., top stories).

At screenshot 904, the electronic device (100) identifies the objects from the plurality of content in the screenshot such as the image blocks and the text blocks. At screenshot 906, the electronic device (100) analyzes the spaces between each of the image blocks and the text blocks. Further, the electronic device (100) determines the image block and the text block which are in proximity to each other i.e., the image block and text block with less space between each other and also the image block and the text block which are not in proximity to each other i.e., the image block and the text block with larger space between each other.

At screenshot 908, the electronic device (100) combines the closely spaced at least one image block and the at least one text block to form at least one data item and checks whether the data item threshold hold good for the generated at least one data item. On determining that the data item threshold hold good for the at least one data item generated by the electronic device (100), the at least one data item is presented to the user.

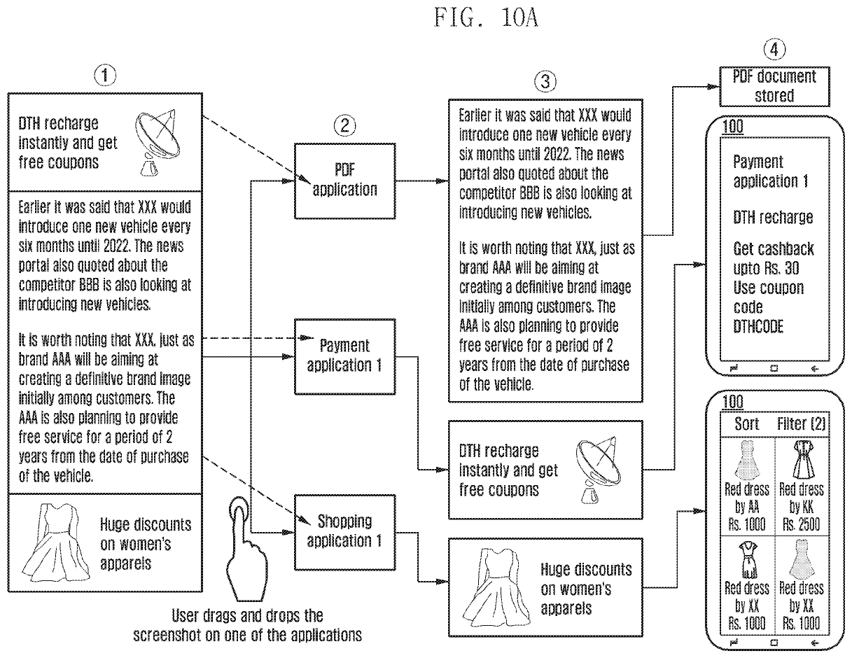

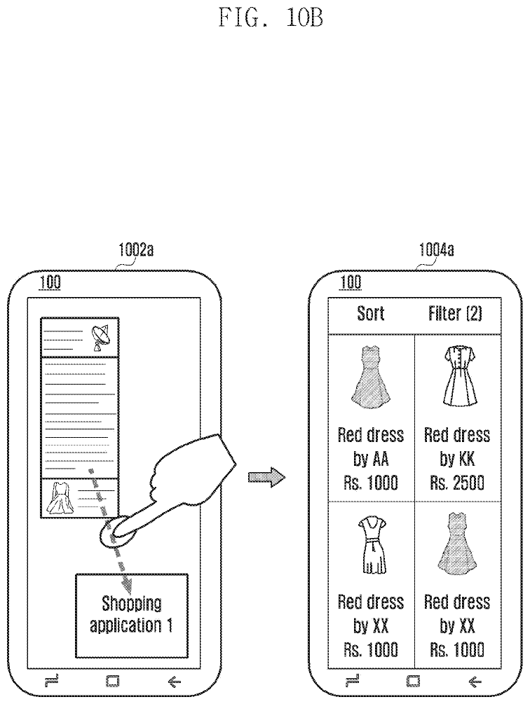

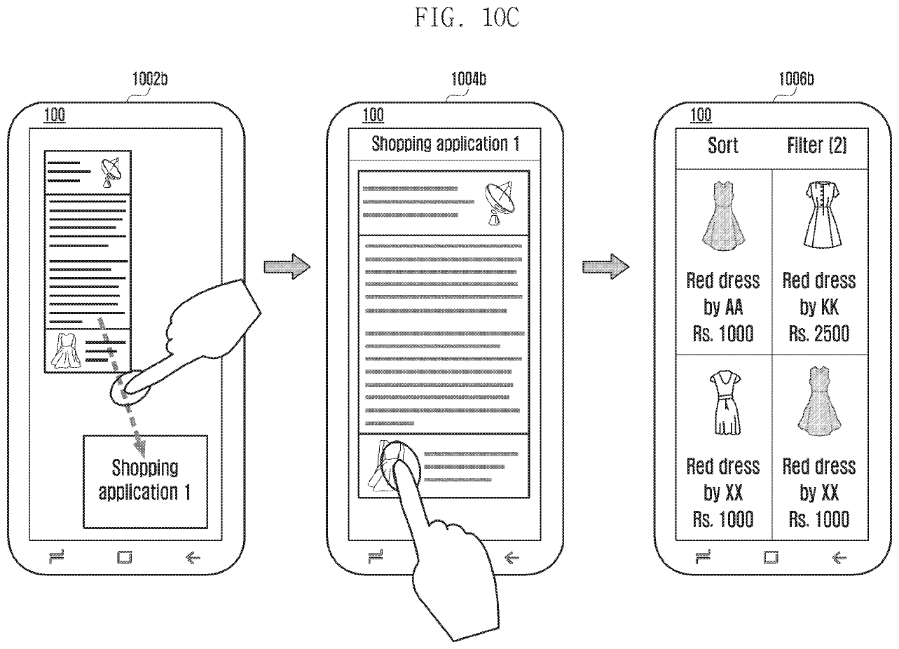

FIG. 10A is an example illustrating the user performing the at least one action using a relevant application on the at least one data item generated from the screenshot, according to an embodiment of the disclosure.

Referring to FIG. 10A, at operation 1, consider that the electronic device (100) has generated three data items i.e., a first data item, a second data item and a third data item from the screenshot based on the plurality of data item parameters associated with the contents in the screenshot. The three data items include a text block from an article, a coupon related to recharging a mobile phone and an image block containing a women's apparel.

At operation 2 shown in FIG. 10A, consider that the user drags and drops the entire screenshot on a documentation related application such as s portable document format (PDF) application. The electronic device (100) analyzes the screenshot and identifies that the second data item is related to the PDF application. At operation 3 shown in FIG. 10A, the electronic device (100) generates a PDF document using the second data item and at 4, stores the PDF document as the file in the electronic device (100).

Similarly, at operation 2 shown in FIG. 10A, consider that the user drags and drops the entire screenshot on a payment application 1. The electronic device (100) analyzes the screenshot and identifies that the first data item is related to the payment application 1. At operation 3 shown in FIG. 10A, the electronic device (100) determines that the first data item comprises a coupon code for a direct to home (DTH) recharge and at operation 4 shown in FIG. 10A, provides the user interface for performing the DTH recharge using the payment application 1.

Similarly, at operation 2 shown in FIG. 10A, consider that the user drags and drops the entire screenshot on a shopping application 1. The electronic device (100) analyzes the screenshot and identifies that the third data item is related to the shopping application 1. At operation 3 shown in FIG. 10A, the electronic device (100) determines that the third data item includes the image block containing the women's apparel and at operation 4 shown in FIG. 10A, the electronic device (100) generates a search query using the image block and provides results related to the search query in the shopping application 1.

Further, in case at operation 2 shown in FIG. 10A, the user drags and drops the entire screenshot on an unrelated application such as for example a gaming application, then the electronic device (100) does not perform any action and simply stores the screenshot in the data item database (142c). Therefore, in the proposed method the user can perform various actions on the screenshot by just dragging and dropping the screenshot on a relevant application, thereby enhancing seamless user experience.

FIG. 10B is an example illustrating the user performing the at least one action using a relevant application using the at least one data item selected by the electronic device (100), according to an embodiment of the disclosure.

Referring to FIG. 10B, at screenshot 1002a, consider that the user drags and drops the screenshot comprising the three data items on the shopping application 1. In the preferred example embodiment, at screenshot 1004a, the electronic device (100) automatically determines the data item associated with the shopping application 1 and generates the search query and populates the results based on the search query.

FIG. 10C is an example illustrating the user performing the at least one action using a relevant application using the at least one data item selected by the user, according to an embodiment of the disclosure.

Referring to FIG. 10C, in conjunction with the FIG. 10B, at screenshot 1002b, the user drags and drops the screenshot comprising the three data items on the shopping application 1. In the preferred example embodiment, at screenshot 1004b shown in FIG. 10C, the electronic device (100) allows the user to select the data item using which the search query needs to be generated. Further, at screenshot 1006b shown in FIG. 10C, the electronic device (100) generates the search query based on the data item selected by the user and populates the results based on the search query.

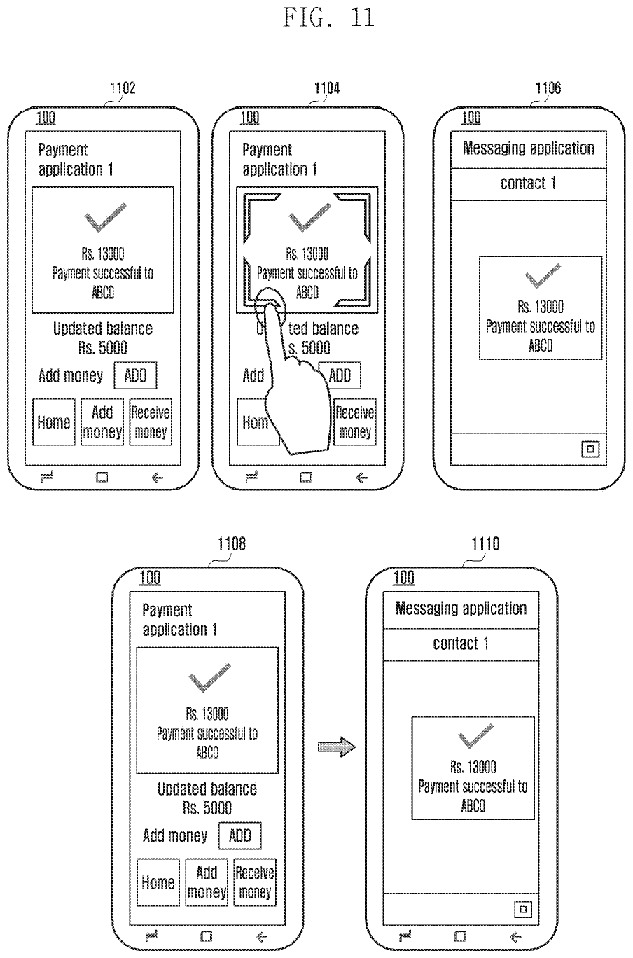

FIG. 11 is an example illustrating the performing of the at least one action on the at least one data item based on the user behavior and learning, according to an embodiment of the disclosure.

Consider the user makes a periodic payment like rent payment using a payment application 1 in the electronic device (100), as shown in 1102 of FIG. 11. At screenshot 1104 of FIG. 11, the user captures the screenshot of the rent payment in the electronic device (100) and crops the irrelevant portions to retain only the relevant portions to be shared to a user contact. At screenshot 1106 of FIG. 11, the user then shares the cropped screenshot as proof of payment to the user contact. The user behavior of screen capture is analyzed by the electronic device (100) to learn a recurring pattern of the user behavior such as screenshot of the rent payment. Further, based on the learning the electronic device (100) can fill the information of the user contact to which the user frequently shares the rent payment screenshot automatically in the payment application 1.

At screenshot 1108 of FIG. 11, the user again makes the rent payment using the payment application 1. The electronic device (100) based on the learning automatically generates the data item which includes only a section of the screenshot which the user usually shares from the screenshot and also suggests the user contact for sharing the data item using the messaging application (e.g., at screenshot 1110 of FIG. 11).

Therefore, in the methods and systems of the related art the user has to perform a plurality of steps before sharing the portion of the screenshot especially payment confirmations in case of the rent payment. Unlike to the methods and systems of the related art, in the proposed method the periodic behavior of the user is learnt continuously and based on the learning the sharable data item is automatically generated comprising only the portion of the screenshot generally shared by the user. Also, the electronic device (100) automatically suggests the user contact to which the data item needs to be shared based on the learning. Therefore, the proposed method reduces dependency on the user to perform a series of steps and enhances ease of usage.

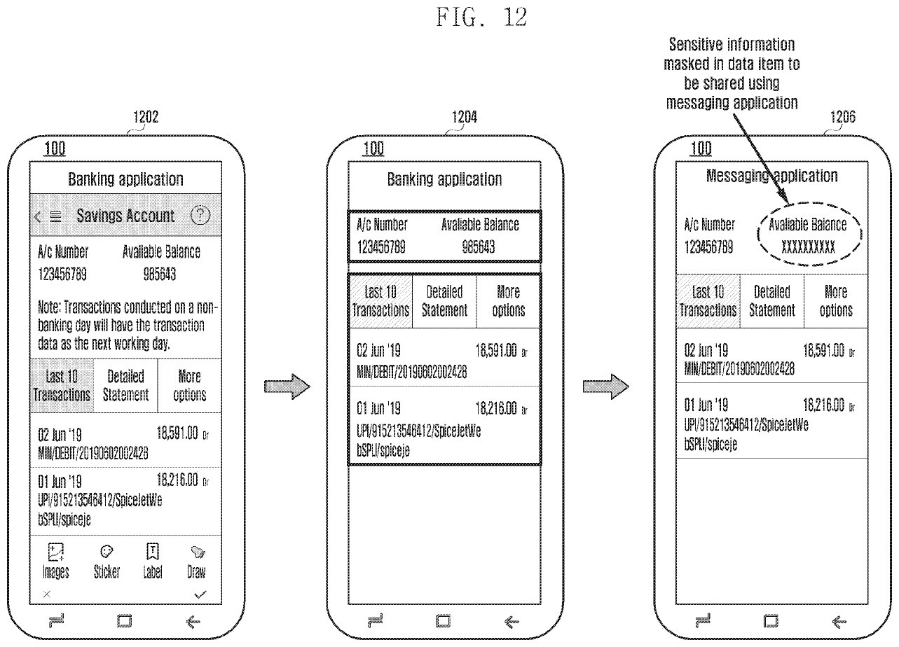

FIG. 12 is an example illustrating automatically masking of sensitive information in the screenshot, according to an embodiment of the disclosure.

Consider the user makes payments such as a rent payment from user bank account to another bank account suing a banking application. The rent payment is reflected in the user transaction details in the user's bank account and the user captures the screenshot of the transaction details from the banking application, as shown in screenshot 1202 of the FIG. 12.

At screenshot 1204 of FIG. 12, the electronic device (100) automatically generates the data item from the screenshot by removing a header and footer from the screenshot, removing a ‘Note’ portion in the screenshot which does not hold any value to a receiving user. Further, the electronic device (100) determines the plurality of data item parameters associated with the content in the screenshot and merges the contents based on the plurality of data item parameters associated with the content to form meaningful data items i.e., all transaction details are merged to form a single data item. Further, the electronic device (100) highlights the at least one data item generated, so that the user can select the data item which the user wants to share without using any editing tools.

At screenshot 1206 of FIG. 12, the electronic device (100) determines based on user behavior and learning that the sensitive information in the screenshot such as account balance which may not be required to be shared to the receiving user using the messaging application. Hence, the electronic device (100) automatically masks the sensitive information in the data items before providing the same to the user for sharing using the messaging application. Further, in case the user wishes to share the sensitive information in the data item, then the electronic device (100) also allows the user options to un-mask the sensitive information.

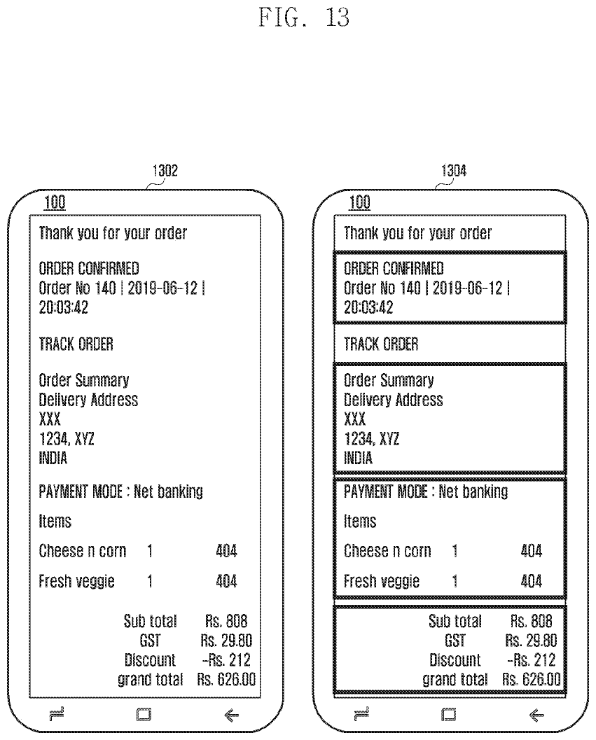

FIG. 13 is an example illustrating auto-generation of at least one data item from the screenshot, according to an embodiment of the disclosure.

Consider a user orders pizza from a store and generates a payment invoice for the purchase of the pizza. The user then captures the screenshot of the invoice generated after the purchase in the electronic device (100), as shown in screenshot 1302.

At screenshot 1304, the electronic device (100) receives the screenshot which comprises various contents such as order details including order number, date and time of order placement; order summary; payment mode and total billing details with tax information, etc. based on the plurality of data item parameters. The electronic device (100) then generates the at least one data item based on the plurality of data item parameters.

The generation of the at least one data item does not require much user input. The at least one data item generated by the electronic device (100) is provided to the user for selection which can be selected with a tap and shared directly i.e., the order summary data item can be selected and shared by the user directly. Also, the user can select multiple data items at different locations of the screen of the electronic device (100).

In another embodiment, the electronic device (100) extracts selectable text from the screenshot which can be copied to a clipboard and shared by the user.

In another embodiment, the electronic device (100) determines a context between the at least one image block and the at least one text block and then the at least one image block and the at least one text block having the same context is combined to form the at least one data item.

While the disclosure has been shown and described with reference to various embodiments thereof, it will be understood by those skilled in the art that various changes in form and details may be made therein without departing from the spirit and scope of the disclosure as described by the appended claims and their equivalents.

What is claimed is:

1. A method for generating at least one data item from a screenshot in an electronic device, the method comprising:
detecting, by the electronic device, a screenshot comprising content displayed on a screen of the electronic device;
determining, by the electronic device, a plurality of data item parameters associated with the content in the screenshot;
generating, by the electronic device, at least one data item from the screenshot based on the plurality of data item parameters; and
storing, by the electronic device, the at least one data item in a file in the electronic device.

2. The method as claimed in claim 1, further comprising performing, by the electronic device, at least one action in the electronic device using the at least one data item.

3. The method as claimed in claim 1, wherein detecting, by the electronic device, the screenshot comprising the content displayed on a screen of the electronic device comprises:
receiving a first image of the content displayed on a screen of the electronic device;
determining a plurality of attributes associated with the content displayed in the first image of the screen of the electronic device;
determining whether the content displayed in the first image is complete based on the plurality of attributes;
displaying an indication to scroll the content in at least one direction in response to determining that the content displayed in the first image is not complete;
receiving at least one second image of a scrolled content displayed on the screen of the electronic device; and
detecting the screenshot based on the first image and the at least one second image.

4. The method as claimed in claim 1, wherein the generating, by the electronic device, of the at least one data item from the screenshot based on the plurality of data item parameters comprises:
displaying a plurality of objects available in the screenshot based on the plurality of data item parameters;
detecting at least two objects from the plurality of objects selected by a user;
selecting the at least two objects; and
generating a data item by automatically merging the selected at least two objects.

5. The method as claimed in claim 1, wherein generating, by the electronic device, at least one data item from the screenshot based on the plurality of data item parameters comprises:
determining a context associated with a plurality of objects available in the screenshot based on the plurality of data item parameters;
determining a weightage of each of the objects based on the context;
determining a set of objects from the plurality of objects for which the weightage meets a data item threshold; and
generating at least one data item by automatically merging the set of objects.

6. The method as claimed in claim 1, wherein the plurality of data item parameters comprises an outline of the content, proximity of objects of the content and attributes of the content.

7. The method as claimed in claim 6, wherein the outline of the content comprises information about at least one of edges of objects available in the screenshot, line segments of objects available in the screenshot, angle of objects available in the screenshot, or a screen size of objects available in the screenshot.

8. The method as claimed in claim 6, wherein the attributes of the content comprise metadata information of the objects available in the screenshot.

9. The method as claimed in claim 6, wherein the proximity of the objects of the content indicates a distance between the objects available in the screenshot.

10. An electronic device for generating at least one data item from a screenshot, the electronic device comprising:
a memory; and
at least one processor coupled to the memory and configured to:
detect a screenshot comprising content displayed on a screen of the electronic device,
determine a plurality of data item parameters associated with the content in the screenshot,
generate at least one data item from the screenshot based on the plurality of data item parameters, and
store the at least one data item in a file in the electronic device.

11. The electronic device as claimed in claim 10, wherein the at least one processor is further configured to perform at least one action in the electronic device using the at least one data item.

12. The electronic device as claimed in claim 10, wherein the at least one processor is further configured to detect the screenshot comprising the content displayed on a screen of the electronic device by:
receiving a first image of the content displayed on a screen of the electronic device;
determining a plurality of attributes associated with the content displayed in the first image of the screen of the electronic device;
determining whether the content displayed in the first image is complete based on the plurality of attributes;
displaying an indication to scroll the content in at least one direction in response to determining that the content displayed in the first image is not complete;
receiving at least one second image of a scrolled content displayed on the screen of the electronic device; and
detecting the screenshot based on the first image and the at least one second image.

13. The electronic device as claimed in claim 10, wherein the at least one processor is further configured to generate the at least one data item from the screenshot based on the plurality of data item parameters by:
displaying a plurality of objects available in the screenshot based on the plurality of data item parameters;
detecting at least two objects from the plurality of objects selected by a user;
selecting the at least two objects; and
generating a data item by automatically merging the selected at least two objects.

14. The electronic device as claimed in claim 10,
wherein the at least one processor is further configured to generate at least one data item from the screenshot based on the plurality of data item parameters by:
determining a context associated with a plurality of objects available in the screenshot based on the plurality of data item parameters;
determining a weightage of each of the objects based on the context;
determining a set of objects from the plurality of objects for which the weightage meets a data item threshold; and
generating at least one data item by automatically merging the set of objects.

15. The electronic device as claimed in claim 10, wherein the plurality of data item parameters comprises an outline of the content, proximity of objects of the content and attributes of the content.

16. The electronic device as claimed in claim 15, wherein the outline of the content comprises information about at least one of edges of objects available in the screenshot, line segments of objects available in the screenshot, angle of objects available in the screenshot, or a screen size of objects available in the screenshot.

17. The electronic device as claimed in claim 15, wherein the attributes of the content comprise metadata information of objects available in the screenshot.

18. The electronic device as claimed in claim 15, wherein the proximity of the objects of the content indicates a distance between objects available in the screenshot.
